(19) United States
(12) Patent Application Publication
(10) Pub. No.: US 2020/0009746 A1
(43) Pub. Date: Jan. 9, 2020

(54) ROBOTIC FOREARMS

(71) Applicant: SWIFT ENGINEERING, INC., San Clemente, CA (US)

(72) Inventor: Joseph YOUNG, Dana Point, CA (US)

(21) Appl. No.: 16/027,157

(22) Filed: Jul. 3, 2018

(51) Int. Cl. B25J 17/00

(52) U.S. Cl. CPC B25J 17/00

(57) ABSTRACT

Joints for facilitating relative motion between a first part of a machine, such as a robot, and a second part of the machine may include linear actuators connecting the first part to the second part and a shaft member connecting the first part to the second part. Each of the linear actuators may be oriented at an oblique angle relative to the shaft member. The first and second parts of the machine may be parts of a robotic arm, such as other robotic joints or an end-effector, such as a robotic hand. The joints may facilitate simulation of the movement and dexterity of human body parts, such as a human wrist and forearm.

### BACKGROUND

Robots and similar devices typically have multiple parts or segments that move and articulate relative to each other. An existing robotic arm may be connected to, and move relative to, a support or a body about multiple axes with multiple degrees of freedom. For example, an existing robotic arm may have a shoulder joint connected to an elbow joint via an arm segment, or may include another quantity or type of moving joints. An elbow joint may carry another arm segment. Existing robotic arms may have end-effectors, such as gripping devices or other tools, for accomplishing a task. Accordingly, existing robotic arms may be able to move an end-effector to various locations to accomplish tasks.

But existing robotic arms rely on rotary connections or rotary joints between parts or segments to facilitate relative movement between the parts. Each rotary joint includes a motor that provides a rotational range of motion about a single axis, constraining the motion to one degree of freedom. To provide additional degrees of freedom, multiple rotary joints must be placed in series. For example, to approximate a shoulder or elbow joint, a designer may implement two rotary joints in series with each other in a given joint, with their rotational axes oblique or orthogonal to each other. Specifically, a shoulder joint may be approximated by using a rotary joint for flexion and extension, attached to another rotary joint for abduction and adduction.

Existing robotic mechanisms often provide multiple degrees of freedom, but they do not provide ideal anthropomorphic movement or dexterity. Human joints are more complex than existing robotic joints and have different capabilities and limitations. For example, a human wrist and forearm facilitates movement of a human hand relative to the remainder of the human arm through flexion, extension, pronation, and supination, and each movement has its own capabilities and limitations.

In addition, combinations of rotary joints increase the weight of a robotic system. Increased weight is especially problematic as the number of joints and the length of a robotic arm increases. For example, a heavy wrist or elbow joint requires a strong shoulder joint. As weight increases towards the distal or free end of a robotic arm, the resultant payload that such an arm can carry decreases.

### SUMMARY

Representative embodiments of the present technology include a joint for a machine (such as a robot) configured to facilitate relative motion between a first part of the machine and a second part of the machine. The joint may include first, second, and third linear actuators connecting the first part to the second part and a shaft member connecting the first part to the second part. The joint may facilitate the approximation of movement and dexterity of human body parts, such as a human wrist and forearm.

In some embodiments, each of the linear actuators may be oriented at an oblique angle relative to the shaft member. In some embodiments, one or more of the linear actuators may be connected to the first part or to the second part via a clevis or a magnetic ball joint.

In some embodiments, the shaft member may include a longitudinal axis and it may be connected to the first part or the second part via a bearing. The shaft member may be positioned to rotate about the longitudinal axis relative to the first part or the second part. The shaft member may be positioned between the first linear actuator, the second linear actuator, and the third linear actuator. The shaft member may have a fixed length, and it may prevent the first or second parts from moving toward or away from each other along the longitudinal axis.

Another representative embodiment of the present technology may include a machine with a robotic arm and an end-effector. The robotic arm may include a plurality of arm portions configured to articulate relative to each other. At least one of the arm portions may include a joint supporting the end-effector, the joint including a distal base carrying the end-effector, a proximal base (for connecting to another part of the robotic arm, for example), a plurality of linear actuators movably connected to the distal base and to the proximal base, and a shaft member connected to the distal base and to the proximal base. The end-effector may be a robotic hand.

Other features and advantages will appear hereinafter. The features described above can be used separately or together, or in various combinations of one or more of them.

### BRIEF DESCRIPTION OF THE DRAWINGS

In the drawings, wherein the same reference number indicates the same element throughout the several views:

FIG. 1 illustrates a machine in the form of a robotic arm supported by a support, in accordance with an embodiment of the present technology.

FIGS. 2 and 3 illustrate detailed views of the robotic forearm shown in FIG. 1.

FIG. 4 illustrates a partially disassembled view of the robotic forearm shown in FIGS. 1-3.

FIG. 5 illustrates a robotic forearm according to another embodiment of the present technology.

FIG. 6 illustrates a robotic forearm according to another embodiment of the present technology.

FIG. 7 illustrates a magnetic ball joint as found in the prior art.

### DETAILED DESCRIPTION

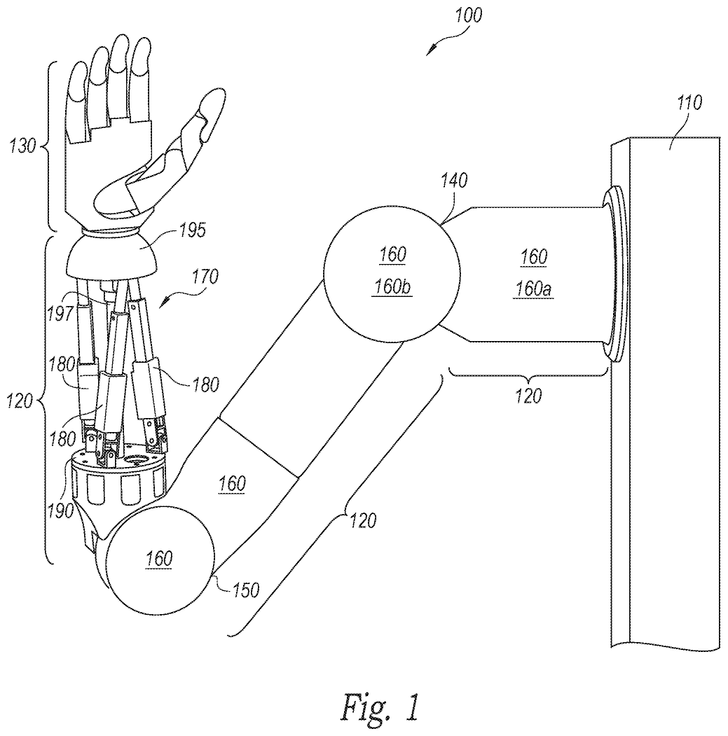

The present technology is directed to robotic forearms and associated systems and methods. Various embodiments of the technology will now be described. The following description provides specific details for a thorough understanding and enabling description of these embodiments. One skilled in the art will understand, however, that the invention may be practiced without many of these details. Additionally, some well-known structures or functions, such as structures or functions common to actuators, encoders, wiring, and controls, may not be shown or described in detail so as to avoid unnecessarily obscuring the relevant description of the various embodiments. Accordingly, embodiments of the present technology may include additional elements or exclude some of the elements described below with reference to FIGS. 1-7, which illustrate examples of the technology.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this detailed description section.

Where the context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all of the items in the list, or (c) any combination of items in the list. Further, unless otherwise specified, terms such as “attached” or “connected” are intended to include integral connections, as well as connections between physically separate components.

Specific details of several embodiments of the present technology are described herein with reference to robotic forearms. The technology may also be used with other types of machines or robotic assemblies in which similar movement capabilities and patterns are desirable, including robotic legs or other anthropomorphic or non-anthropomorphic mechanisms.

Turning now to the drawings, FIG. 1 illustrates a machine in the form of a robotic arm 100 supported by a support 110, in accordance with an embodiment of the present technology. The support 110 is illustrated as a static post but, in various embodiments of the present technology, the support 110 can have other forms including, for example, further robotic components or an anthropomorphic torso. The robotic arm 100 may include a plurality of arm portions 120 and an end-effector 130. The end-effector 130 may be in the form of a tool, claw, hand, or other device for performing a task. In a particular embodiment, the end-effector 130 is a mechanical or robotic hand. The arm portions 120 can move or articulate relative to each other to provide movement of the end-effector among several degrees of freedom.

Movement of the arm portions 120 relative to each other and to the support 110 may be facilitated by motorized joints. For example, the arm 100 may include a shoulder joint 140 and an elbow joint 150. The shoulder and elbow joints 140, 150 may resemble traditional robotic arm joints. For example, one or both of the shoulder and elbow joints 140, 150 may be formed by a pair of motorized rotary joints 160 in series, with their axes oriented obliquely or orthogonally to each other.

With specific regard to the shoulder joint 140, a first motorized rotary joint 160a and a second motorized rotary joint 160b may be positioned in series with each other with their rotational axes oriented at oblique or orthogonal angles relative to each other. Such a series arrangement of motorized rotary joints facilitates movement of arm portions 120 relative to each other through several degrees of freedom. The elbow joint 150, with its own series of rotary joints 160, provides additional degrees of freedom. However, as described above, using motorized rotary joints in series can result in heavy robotic arms or arms that do not readily approximate all necessary anthropomorphic movements for a robotic arm.

In accordance with embodiments of the present technology, a robotic forearm 170 may connect the elbow joint 150 to the end-effector 130. The robotic forearm 170 may form all or part of the arm portion 120 between the elbow joint 150 and the end-effector 130, and it may function as a wrist joint to provide anthropomorphic wrist movement to the end-effector 130 (such as a robotic hand).

The robotic forearm 170 may include a plurality of linear actuators 180 rather than motorized rotary joints (such as the rotary joints 160 shown in FIG. 1). In some embodiments, the robotic forearm 170 may include a proximal base 190 that mounts the forearm to a surface, mechanism, or other part, such as to an elbow joint 150 or the remainder of a robotic arm 100. In some embodiments, the robotic forearm 170 may include a distal base 195 that carries or supports the end-effector 130. The linear actuators 180 and a shaft member 197 connect the proximal base 190 to the distal base 195, and facilitate motion of the distal base 195 relative to the proximal base 190 in three degrees of freedom with anthropomorphic characteristics, as described in detail below.

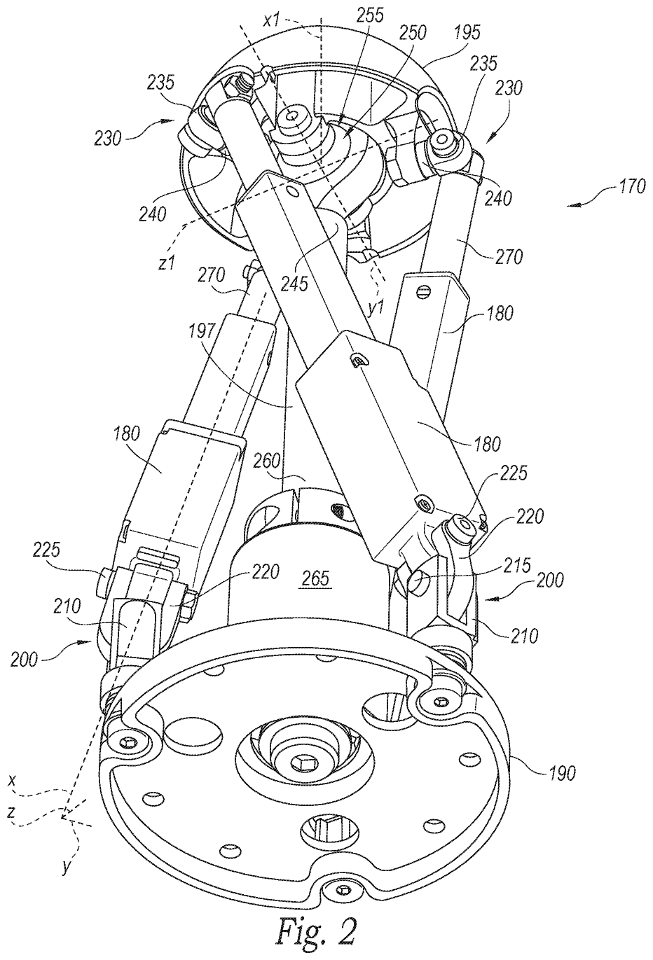

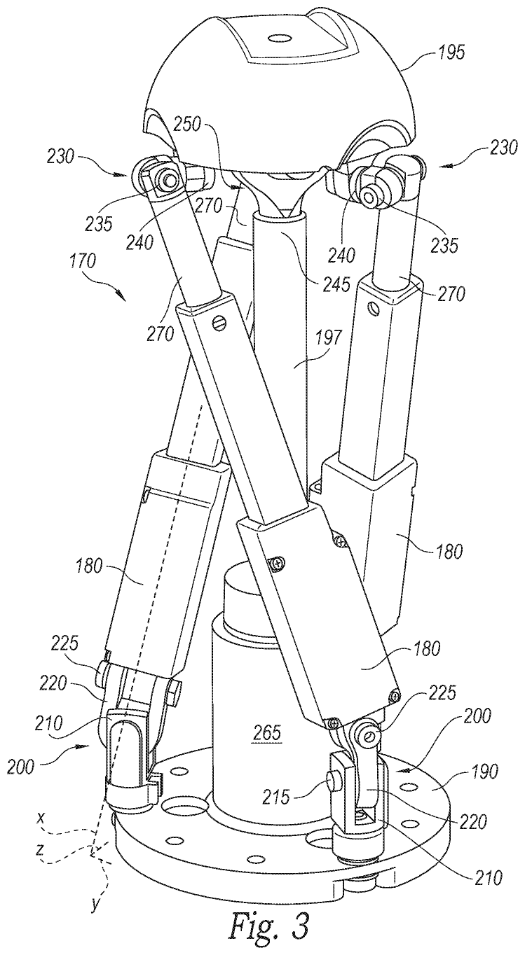

FIGS. 2 and 3 illustrate detailed views of the robotic forearm 170 shown in FIG. 1. The proximal base 190 may be mounted to a surface (not shown) or mechanism (not shown) via conventional means, such as fasteners, adhesive, welding, or other suitable means. One or more of the linear actuators 180 may be connected to the proximal base 190 using one or more proximal kinematic connectors 200, which facilitate pivoting and rotational movement of the linear actuators relative to the proximal base 190 using one or more movable components. Each proximal kinematic connector 200 facilitates rotation and pivoting of a linear actuator 180 about its lengthwise axis x, its transverse axes y and z, and combinations of axes x, y, and z.

In some embodiments, a proximal kinematic connector 200 may include a first or proximal clevis 210 pivotably connected to the proximal base 190, such that the clevis 210 can rotate relative to the proximal base 190 via a bearing or other rotating connection. A proximal pin 215 passes through the proximal clevis 210 and through a second or distal clevis 220 to restrain the second or distal clevis 220 to the proximal clevis 210 and facilitate rotation between the proximal clevis 210 and the distal clevis 220. The distal clevis 220 may be connected to the linear actuator 180 via another rotating or pivoting connection, such as a distal pin 225. Each of the pins 215, 225 may be unthreaded pins suitably restrained in their respective clevises (such as with a cotter pin or cotter ring), or they may be threaded bolts or other fasteners. The proximal kinematic connectors 200 may have any suitable form (not limited to arrangements involving clevises) capable of connecting the linear actuators 180 to the proximal base 190 and providing pivoting and rotation of the linear actuators 180 relative to the proximal base 190.

Each linear actuator 180 is connected to the distal base 195 (which may support an end-effector, such as a hand, as illustrated in FIG. 1) via one or more distal kinematic connectors 230. The distal kinematic connectors 230 facilitate relative movement between the distal base 195 and the linear actuators 180.

In some embodiments, a distal kinematic connector 230 may include a first distal pivot joint 235 and a second distal pivot joint 240. The distal pivot joints 235, 240 may be oriented such that their rotational axes are obliquely or orthogonally oriented relative to each other to facilitate movement between the distal base 195 and the linear actuators 180 in multiple degrees of freedom. The distal kinematic connectors 230 may include or be made of any suitable mechanical arrangement (which may or may not include arrangements involving pivot joints) that facilitates relative movement about one or more axes or in multiple degrees of freedom between the distal base 195 and the linear actuators 180, such as pivoting and rotation.

The linear actuators 180, and their corresponding proximal kinematic connectors 200 and distal kinematic connectors 230 (for example, three linear actuators 180, each having a proximal kinematic connector 200 and distal kinematic connector 230) facilitate actuation or movement of the distal base 195 relative to the proximal base 190. When the distal base 195 moves, the end-effector 130 attached to the distal base 195 may also move.

The shaft member 197 may also connect the proximal base 190 to the distal base 195. A distal end 245 of the shaft member 197 may be connected to the distal base 195 via another distal kinematic connector 250. The distal kinematic connector 250 connecting the distal end 245 of the shaft member 197 to the distal base 195 may facilitate rotation of the distal base 195 about a longitudinal axis x1 projecting along the length of the shaft member 197 from the proximal base 190; about an axis y1 perpendicular to the axis x1 (allowing pitch or roll relative to the proximal base 190); about an axis z1 perpendicular to the axes x1 and y1; or about a combination of the axes x1, y1, z1. Accordingly, the distal base 195 may move in at least three-degrees of freedom (for example, roll, pitch, and yaw) to move the end-effector 130 attached to the distal base 195 relative to the proximal base 190.

In some embodiments, the distal kinematic connector 250 connecting the distal end 245 of the shaft member 197 to the distal base 195 may include a ball joint 255 rotationally mounted to the distal end 245. Such a ball joint 255 facilitates rocking or pivoting of the distal base 195 about multiple axes, while the rotational connection to the distal end 245 allows the distal base 195 to twist about the axis x1 extending through the shaft member 197.

The proximal end 260 of the shaft member 197 is connected to the proximal base 190. The shaft member 197 may be rigidly or fixedly connected to the proximal base 190, or it may be rotatably connected to the proximal base 190 via a rotational bearing 265. The shaft member 197 may be fixed in length, such that it does not allow the distal base 195 to translate relative to the proximal base 190. For example, the proximal kinematic connectors 200, the linear actuators 180, and the distal kinematic connectors 230, 250 may facilitate pivoting or rotation of the distal base 195 relative to the proximal base 190, while the distal base 195 may be prevented from moving toward or away from the proximal base 190. In some embodiments, however, the shaft member 197 may include a linear actuator to facilitate translation of the distal base 195 toward and away from the proximal base 190.

In operation, the linear actuators 180 extend and retract (by extending and retracting their respective pistons 270), working in tandem to push, pull, and rotate the distal base 195 into various positions relative to the proximal base 190. In embodiments employing a fixed-length shaft member 197, the shaft member 197 maintains the distal base 195 a fixed distance from the proximal base 190. Accordingly, the robotic forearm 170 provides three degrees of freedom of movement of the distal base 195, including pronation/supination, flexion/extension, and radial/ulnar deviation (rotation), to simulate or approximate human wrist movement for improved anthropomorphic characteristics. When coupled with an upper arm assembly having four or more degrees of freedom, such as an elbow joint and a shoulder joint (see FIG. 1), a complete arm assembly may provide seven or more degrees of freedom of movement for an end-effector, such as a hand.

To provide rotation of the distal base 195 (such as about the axis x1 in FIG. 2), the linear actuators 180 may be oriented at oblique angles relative to the shaft member 197. Orienting the linear actuators at oblique angles also facilitates dividing the force output of a single linear actuator 180 into components that rotate the distal base 195 and pivot, tilt, or rock the distal base 195.

In some embodiments, the linear actuators 180 may be slanted, relative to the axis x1 extending along the shaft member 197, by an angle between approximately 10 and 30 degrees (such as 20 degrees), or another angle suitable for dividing the force output of a linear actuator into components to rotate and pivot, tilt, or rock the distal base 195 relative to the proximal base 190. In some embodiments, the slant of the linear actuators may be provided by designing or assembling the robotic forearm 170 such that the distal base 195 is rotated about the axis x1 relative to the proximal base 190 by an angle between approximately 40 and 60 degrees (such as 50 degrees), to cause the linear actuators 180 to tilt away from an orthogonal position relative to the proximal base 190. Such an arrangement—in which the linear actuators 180 are slanted relative to the proximal and distal bases 190, 195—facilitates rotation of the distal base 195 relative to the proximal base 190 via the shaft member 197 through approximately 90 degrees of rotation (for example, 45 degrees in one direction and 45 degrees in the opposite direction) to contribute to pronation and supination of the end-effector 130. In other terms, the linear actuators 180 are slanted to provide rotation about the x1 axis (along the shaft member 197).

Advantages of arrangements of linear actuators 180 according to embodiments of the present technology include a decrease in the required torque for any single rotation axis, which corresponds to lower power requirements and lower mass relative to traditional mechanisms that rely on rotary actuators. For example, the arrangements of linear actuators 180 within robotic forearms in accordance with embodiments of the present technology provide an additive or cumulative force at the distal base 195 so that one single linear actuator need not be (but may be) powerful enough to move the distal base 195 on its own.

In addition, the linear actuators 180 and the shaft member 197 may form the anthropomorphic structure of a robotic forearm, thereby reducing a need for additional structural materials and contributing to further mass savings. For example, in some embodiments, the linear actuators 180 and the shaft member 197 are the only load-bearing or structural supports between the proximal base 190 and the distal base 195.

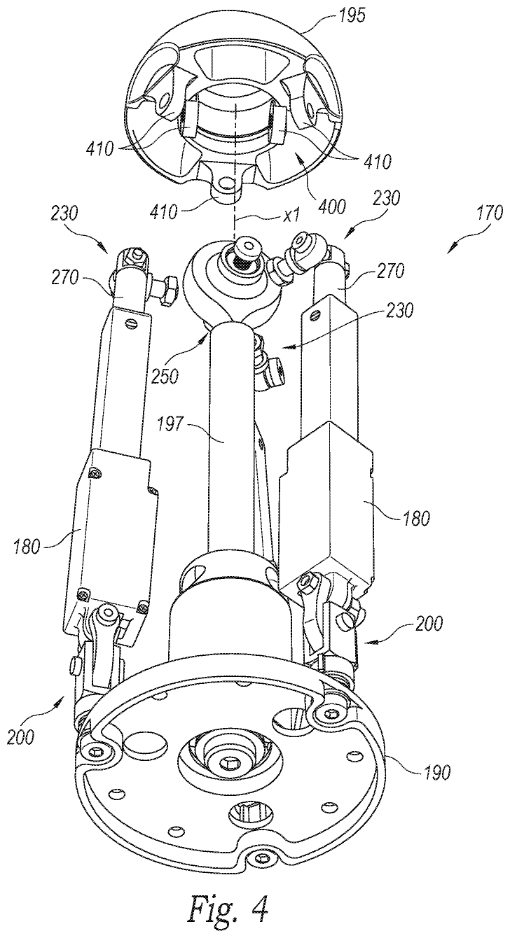

FIG. 4 illustrates a partially disassembled view of the robotic forearm 170 shown in FIGS. 1-3, in which the distal base 195 is separated from the linear actuators 180 and the shaft member 197 to show a detailed view of the distal base 195. The distal base 195 may generally be hemispherical in shape, or it may have other shapes. In some embodiments, the distal base 195 includes a machined base area 400 that includes one or more lobes 410 for connecting the distal kinematic connectors 230, 250 to the distal base 195.

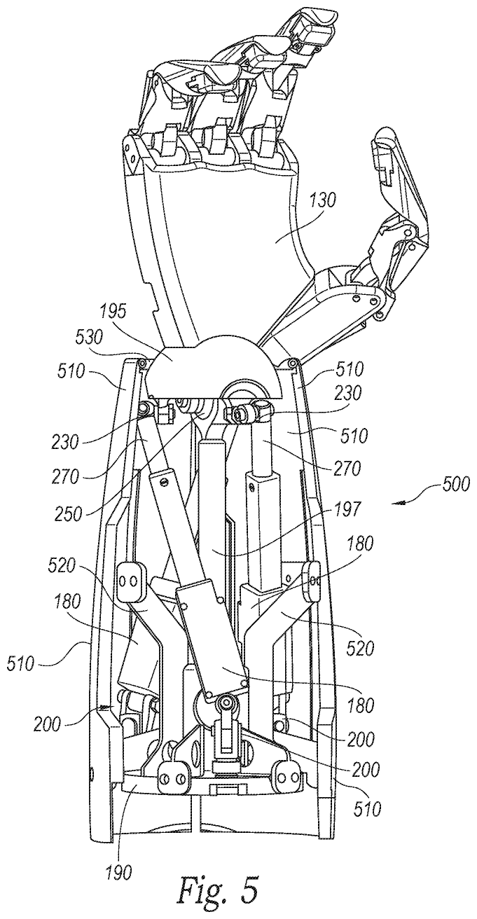

FIG. 5 illustrates a robotic forearm 500 according to another embodiment of the present technology. The robotic forearm 500 may generally be similar to the robotic forearm 170 illustrated and described above with regard to FIGS. 1-4, but it may further include an outer shell or skin 510 wrapped around the forearm 500 to cover or protect the actuators 180, shaft member 197, and associated kinematic connectors, joints, and associated wiring and other parts in the forearm 500. In FIG. 5, the outer shell or skin 510 is not illustrated as completely wrapping around the internal components of the robotic forearm 500 (to avoid obscuring the internal components in the illustration). In various embodiments of the present technology, however, the outer shell or skin 510 may almost entirely or entirely wrap around and cover the internal components within the robotic forearm 500.

The outer shell or skin 510 may be supported by one or more bracket elements 520 carried by, or mounted to, the proximal base 190. A distal opening 530 of the outer shell or skin 510 may allow free movement of the distal base 195 and the end-effector 130. In some embodiments, the outer shell or skin 510 may cover only a portion of the internal components within the robotic forearm 500. The outer shell or skin 510 may facilitate anthropomorphic appearance, for example, by having a shape resembling a human forearm.

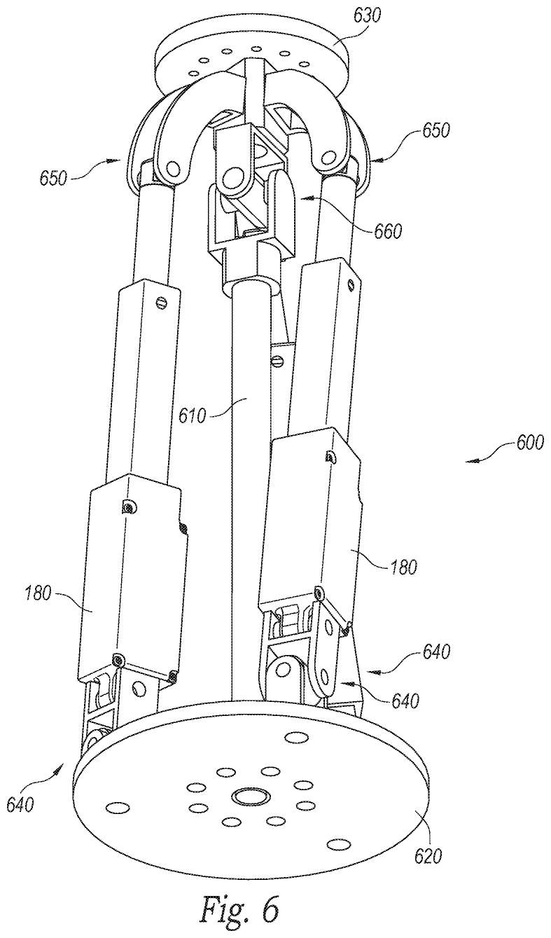

FIG. 6 illustrates a robotic forearm 600 according to another embodiment of the present technology. The robotic forearm 600 illustrated in FIG. 6 may generally be similar to the robotic forearms 170, 500 illustrated and described above. For example, three linear actuators 180 and a shaft member 610 may movably connect a proximal base 620 to a distal base 630, and facilitate wrist-like anthropomorphic motion of the distal base 630 relative to the proximal base 620, in a manner similar to that described above with regard to the robotic forearms illustrated in FIGS. 1-5. However, in some embodiments, the robotic forearm 600 may implement different kinematic connectors between parts, other than the kinematic connectors between parts illustrated and described with regard to FIGS. 1-5.

For example, proximal kinematic connectors 640 may be formed with a pair of orthogonally-oriented pivoting brackets to provide movement (such as pivoting) of the linear actuators 180 relative to the proximal base 620. Each distal kinematic connector 650 between the linear actuators 180 and the distal base 630 may facilitate pivoting between the distal base 630 and a linear actuator 180 around two or more axes. The distal kinematic connector 660 between the shaft member 610 and the distal base 630 may not have a ball joint in some embodiments, instead having a pair of orthogonally-oriented pivoting brackets that may also rotate relative to the longitudinal axis of the shaft member 610 to provide rocking, pivoting, and twisting of the distal base 630 relative to the proximal base 620, similar to the movement of the robotic forearms 170, 500 described above. In general, FIG. 6 illustrates that any suitable kinematic connector providing a plurality of degrees of freedom may be used to connect the linear actuators 180 to the proximal and distal bases 620, 630.

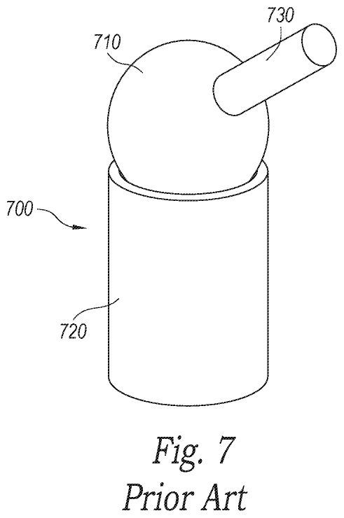

For example, although kinematic connectors (such as 200, 230, 250, 650, 660 or other kinematic connectors) may be illustrated and described herein as including clevis joints, clevises, ball joints, or pivoting brackets, various kinematic connectors may be formed using magnetic ball joints. FIG. 7 is a schematic illustration of a magnetic ball joint 700 known in the prior art and capable of being implemented into embodiments of the present technology. The ball joint 700 includes a ball element 710 seated in a cup or socket element 720. One or both of the ball element 710 or the socket element 720 is magnetized to hold the ball element 710 in the socket element 720. A connecting element 730 (which may have many forms, and is only illustrated schematically) may connect the ball element 710 to a part which is desired to move relative to the socket element 720. The ball element 710 facilitates pivoting and rotation about multiple axes.

An advantage to using a magnetic ball joint 700 as a kinematic connector is that it may be used as a safety mechanism or a mechanical fuse. For example, if a robotic forearm is overstressed or overloaded, the force on the forearm may overpower the magnetic force to temporarily pull the ball element 710 from the socket element 720, instead of permanently destroying a fixed joint. Magnetic ball joints may also improve assembly time and decrease the overall number of parts. In some embodiments, kinematic connectors may include ball-and-socket joints rather than magnetic ball joints.

Control of robotic forearms according to the present technology may be facilitated by controlling the linear actuators individually or in tandem, such as with an inverse kinematic control algorithm. Existing off-the-shelf linear actuators may be used, which may include encoders, limit switches or other means or combinations of means for measuring the position or extension of the linear actuators. In some embodiments, sensors may be implemented in the linear actuators to provide haptic feedback for a user.

The present technology provides robotic forearms that simulate the anthropomorphic movement and dexterity of a human wrist and forearm. It may also provide a lighter weight joint assembly or a joint assembly capable of being contained in a smaller volume relative to conventional rotary joint assemblies. Embodiments of the present technology may be used in telepresence robotics, in a humanoid robot, in human prosthetics, or in other suitable applications.

From the foregoing, it will be appreciated that specific embodiments of the disclosed technology have been described for purposes of illustration, but that various modifications may be made without deviating from the technology, and elements of certain embodiments may be interchanged with those of other embodiments, and that some embodiments may omit some elements.

Further, while advantages associated with certain embodiments of the disclosed technology have been described in the context of those embodiments, other embodiments may also exhibit such advantages, and not all embodiments need necessarily exhibit such advantages to fall within the scope of the technology. Accordingly, the disclosure and associated technology may encompass other embodiments not expressly shown or described herein, and the invention is not limited except as by the appended claims.

1. A joint for a machine configured to facilitate relative motion between a first part of the machine and a second part of the machine, the joint comprising:
a first linear actuator connecting the first part to the second part;
a second linear actuator connecting the first part to the second part;
a third linear actuator connecting the first part to the second part; and
a shaft member connecting the first part to the second part;
wherein the shaft member extends along a longitudinal axis between the first part and the second part, and wherein the second part is rotatable about the longitudinal axis relative to the first part.

2. The joint of claim 1 wherein each of the first linear actuator, second linear actuator, and third linear actuator is oriented at an oblique angle relative to the shaft member.

3. The joint of claim 1 wherein each of the first linear actuator, second linear actuator, and third linear actuator is connected to the first part or to the second part via a clevis.

4. The joint of claim 1 wherein each of the first linear actuator, second linear actuator, and third linear actuator is connected to the first part or to the second part via a magnetic ball joint or a ball-and-socket joint.

5. The joint of claim 1 wherein the shaft member is connected to the first part or the second part via a bearing, and wherein the shaft member is positioned to rotate about the longitudinal axis relative to the first part or the second part.

6. The joint of claim 1 wherein the shaft member is positioned between the first linear actuator, the second linear actuator, and the third linear actuator.

7. A machine comprising a robotic arm and an end-effector, the robotic arm comprising:
a plurality of arm portions configured to articulate relative to each other, at least one of the arm portions comprising a joint supporting the end-effector, wherein the joint comprises:
a distal base carrying the end-effector;
a proximal base;
three linear actuators movably connected to the distal base and to the proximal base; and
a shaft member connected to the distal base and to the proximal base; wherein the shaft member extends along a longitudinal axis between the proximal base and the distal base, and wherein the distal base is rotatable about the longitudinal axis relative to the proximal base.

8. The machine of claim 7 wherein the end-effector is a robotic hand.

9. The machine of claim 7 wherein at least one of the linear actuators is connected to the proximal base via a clevis.

10. The machine of claim 7 wherein at least one of the linear actuators is connected to the proximal base or to the distal base via a magnetic ball joint.

11. The machine of claim 7 wherein the shaft member is connected to the proximal base via a bearing and is positioned to rotate about the longitudinal axis relative to the proximal base.

12. The machine of claim 11 wherein the shaft member prevents the distal base from moving toward or away from the proximal base along a longitudinal axis of the shaft member.

13. The machine of claim 7 wherein the shaft member is positioned between the three linear actuators.

14. The machine of claim 7 wherein each linear actuator of the three linear actuators is slanted relative to the shaft member.

15. A joint for a robot, the joint comprising:
a proximal base for connecting the joint to a first part of the robot;
a distal base for connecting the joint to a second part of the robot;
a plurality of linear actuators connecting the proximal base to the distal base; and
a shaft member connecting the proximal base to the distal base, wherein the shaft member has a fixed length and is rotatable relative to the proximal base about a longitudinal axis extending along the length of the shaft member.

16. The joint of claim 15 wherein at least one of the linear actuators is pivotably connected to the proximal base or to the distal base.

17. The joint of claim 15 wherein at least one of the linear actuators is pivotably connected to the proximal base or to the distal base with a magnetic ball joint.

18. The joint of claim 15 wherein the shaft member is rotatably connected to the distal base.

19. The joint of claim 15 wherein the second part of the robot is an end-effector.

20. The joint of claim 15 wherein the plurality of linear actuators comprises three linear actuators.

21. A machine comprising a robotic arm and an end-effector, the robotic arm comprising:
a plurality of arm portions configured to articulate relative to each other, at least one of the arm portions comprising a joint supporting the end-effector, wherein the joint comprises:
a distal base carrying the end-effector;
a proximal base;
three linear actuators movably connected to the distal base and to the proximal base; and
a shaft member connected to the distal base and to the proximal base, wherein the shaft member prevents the distal base from moving toward or away from the proximal base along a longitudinal axis of the shaft member.
